(19) United States
(12) Patent Application Publication
(10) Pub. No.: US 2008/0116659 A1
(43) Pub. Date: May 22, 2008

(54) QUICK-RELEASE, COMPACT FOLDING BICYCLE

(76) Inventor: Thomas SEAMAN, Portland, OR (US)

Correspondence Address: Leighton K. Chong;Godbey Griffiths Reiss & Chong, Pauahi Tower, 1001 Bishop Street, Suite 2300, Honolulu, HI, 96813, US

(21) Appl. No.: 11/555,612

(22) Filed: Nov. 1, 2006

(51) Int. Cl. B62K 17/00

(52) U.S. Cl. 280/278

(57) ABSTRACT

A folding bicycle has a frame with a front steering tube, main tube, and center seat tube defining a hollow space into which the rear wheel strut with rear wheel are pivoted for storage. The rear wheel strut is mounted to a bottom bracket at the lower end of the center seat tube. A main gear for the bicycle is mounted concentrically with the rear wheel strut such that the distance relationship between the main gear and rear wheel is maintained during folding. A releasable member locks the rear wheel strut in position for riding and unlocks it for folding. Other quick-release members allow the front fork with front wheel, handlebars, and seat to be removed and folded flat with the frame and rear wheel. Using this folding method, a bicycle having 16-inch diameter wheels can be folded into a suitcase-sized space of about 21″×27″×9″.

### TECHNICAL FIELD

The invention is directed to a folding bicycle, and, particularly, to one that has provision for quick-release of parts and foldable components that allow the folded bicycle to fit into a small, compact volume, such as a suitcase.

### BACKGROUND OF INVENTION

In today's crowded traffic environment in urbanized areas, it is desirable to use a bicycle for traveling over short to medium distances. A bicycle provides personal transportation, can carry small loads, is easy and convenient to maneuver and park in crowded places, and is low in cost to purchase and maintain. Automobiles consume large amounts of fossil fuels, create pollution, are a safety hazard, and are costly to maintain and park. Motorcycles have all of the problems of automobiles (though perhaps to a lesser degree) but present a greater safety hazard when operating at high speeds.

To make even greater use of bicycles beyond just point-to-point transport, it would be desirable to have a bicycle which can be quickly disassemble or folded to bring along inside the trunk of a car or as baggage on a train or airplane, so that riders can use them locally at destinations they travel to. While there have been many proposals for folding bicycles, none of them yet provide all of the qualities of being low in cost, being easy and simple to disassemble and fold into a small volume such as a suitcase, maintaining a fixed rear wheel to gear relationship, and being sturdy and reliable to use. Many other folding bicycles necessitate the removal of one or both wheels, which is a messy and complex procedure. Other designs also do not provide the option for incorporating a small engine for assisting with pedaling in a folding bicycle. Some folding bicycles that have sturdy folding frame parts are very expensive and/or utilize heavy metal parts that increase the overall weight. Others that are less costly have folding parts that are not as sturdy, do not fold easily or well, or are excessively heavy.

Some folding bicycle designs in the prior art, such as one designated by the trademark “BIRDY” which is distributed by C.M. Wasson Company, of Palo Alto, Calif., have the main gear and rear wheel at opposite ends of a two-part folding strut that pivots on a rear-mounted rotational axis to fold the main gear and rear wheel into a space inside the frame. However, the use of a two-part folding strut alters the distance and angular relationship of the main gear relative to the rear wheel, and therefore cannot be used with internal gearing drives for the rear hubs other than the chain-type tensioned with derailieur gears. The type of chain drive using derailieur gears is larger, messier and wears faster than one using an internal hub-geared system. Some folding bicycle designs require the complete removal of the rear wheel and drive chain, which makes folding inconvenient and messy.

### SUMMARY OF INVENTION

In accordance with the present invention, a folding bicycle comprises:

(a) a frame having a front steering tube for mounting a front fork for retaining a front wheel at a lower end thereof, a main tube connecting an upper part of the front steering tube to an upper part of a center seat tube, and the center seat tube extending downwardly to a lower end thereof on which a rotatable main gear for driving a rear wheel is mounted concentrically with an end of a rear wheel strut for retaining a rear wheel at a rearward end thereof;

(b) a hollow space defined by the front steering tube, main tube, and center seat tube being configured and having dimensions for accommodating the rear wheel when folded therein; and

(c) a releasable support member engageable between a fixed part mounted to the lower end of the center seat tube and the rear wheel strut for locking the rear wheel strut in position for riding, and disengageable therefrom so as to allow the rear wheel strut to pivot with the rear wheel around the lower end of the center seat tube into the hollow space for storage.

In a preferred embodiment of the folding bicycle, the main tube has a concave curvature in a part extending from the front steering tube to the upper part of the center seat tube matching the curvature of the rear wheel therein when pivoted into the hollow space in the frame. The main gear assembly is arranged coaxially with the pivotable forward end of the rear wheel strut at the lower end of the center seat tube, so that it does not need to be removed and the coupling of its drive chain to the rear wheel can remain intact when the rear wheel is pivoted into the hollow space in the frame.

In one embodiment, the releasable member is formed as a part of a shock absorber assembly having a fixed part mounted adjacent the lower end of the center seat tube, and a support arm coupled to the rear wheel strut. A latch member is provided to lock the fixed part to the support arm for riding, and can be unlatched to release the support arm from the fixed part to allow the rear wheel to be pivoted for storage. An elastomer member is provided in the assembly to absorb vibrations transmitted from the rear wheel when in position for riding. In another embodiment, the releasable member is formed as part of a rear strut assembly to lock the rear wheel strut in a fixed position to the frame for riding, and can be unlatched to unlock the rear strut assembly to pivot the rear wheel for storage.

The joinder of the main tube with the upper part of the center seat tube provides a corner space for an engine-assist unit to be mounted and coupled to the main gear assembly for assisting with pedaling. The engine unit is positioned in the corner space so that it does not need to be removed when pivoting the rear wheel into the hollow space. A releasable front fork coupler couples the upper end of the front fork tube with the bottom end of the front steering tube. The coupler has male and female portions that mate tightly with a slight interference fit, yet can be easily released to remove the front fork with the front wheel for storage. A quick-release goose-neck release pin enables the handlebars to be removed quickly from the front steering tube and stored flat with the other folded parts of the bicycle. A quick-release mechanism is also provided for removal of the seat and seat extension tube from the top end of the center seat tube. For a preferred embodiment having wheels of 16 inches diameter, the entire bicycle can be folded into a suitcase-sized space of about 21″×27″×9″.

Other objects, features, and advantages of the present invention will be explained in the following detailed description of the invention having reference to the appended drawings.

### BRIEF DESCRIPTION OF DRAWINGS

FIG. 1 shows a first embodiment of a folding bicycle in accordance with the present invention in unfolded, assembled form.

FIG. 2 shows the folding bicycle with its rear wheel folded into the frame and its other component parts disassembled to fit into a suitcase-sized space.

FIGS. 3A to 3E show another embodiment of the folding bicycle with its rear wheel in various stages of folding from its locked position for riding to its storage position within the frame.

FIGS. 4A and 4B show detailed side sectional views of the latch member in the embodiment of FIGS. 3A to 3E for locking and unlocking the rear wheel strut assembly to and from its riding position.

FIGS. 5A and 5B show detailed side sectional views of a quick-release release pin for the handlebars.

FIGS. 6A and 6B show detailed side sectional views of a quick-release fork coupler.

FIGS. 7A, 7B and 7C show detailed sectional views of an alternate version of the fork coupler.

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made given the disclosed principles of the invention.

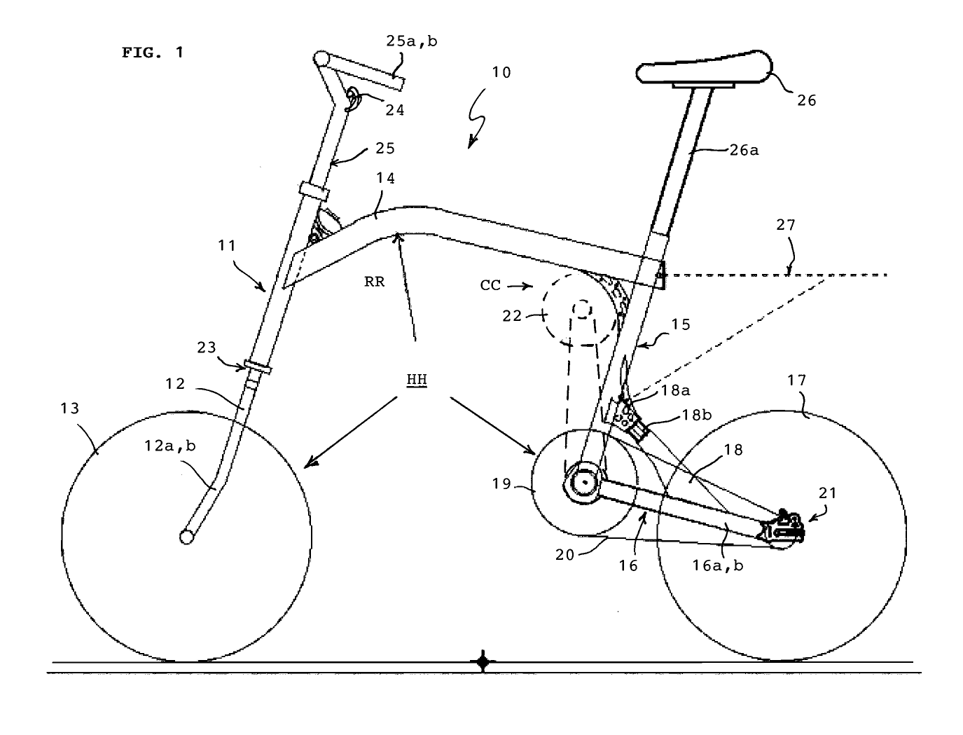

Referring to FIG. 1, a folding bicycle in accordance with the present invention has a frame 10 including a front steering tube 11 which is oriented substantially vertically and mounts a front fork 12 with a pair of front fork arms 12a, 12b spaced apart in parallel for retaining a front wheel 13 at its lower ends, a main tube 14 connecting an upper part of the front steering tube 11 to an upper part of a center seat tube 15, and the center seat tube 15 which is oriented substantially vertically and has its lower end coupled to a pivotable end of a rear wheel strut 16. The rear wheel strut 16 has a pair of rear strut arms 16a, 16b spaced apart in parallel for retaining a rear wheel 17 at its rearward ends. A hollow space HH is defined between the front steering tube 11, main tube 14, and center seat tube 15 of a sufficient size and shape to allow the rear wheel 17 to pivot with the rear wheel strut 16 into a storage position within the hollow space HH.

A releasable support member 18 is provided to couple an intermediate part of the center seat tube 15 with respective connecting parts on the pair of rear strut arms 16a, 16b. When engaged, the support member 18 forms a rigid support at an inclined angle for the rear wheel strut arms 16a, 16b mounting the rear wheel 17. One fixed part 18a of the support member 18 is mounted fixedly to the lower part of the center seat tube 15 and has a release member 18b for quick disengagement from the other part of the support member 18 which is coupled to the rear wheel strut 16. When the release member 18b is disengaged, the released part of the support member 18 can pivot with the rear wheel strut 16 and rear wheel 17 around the lower end (bottom bracket) of the center seat tube 15 and into its storage position in the hollow space HH.

In the preferred embodiment of the folding bicycle, the main tube has a concave curvature in a part extending from the front steering tube 11 to the upper part of the center seat tube 15 (indicated by the radius RR) which is intended to match the curvature of the rear wheel 17 when pivoted into the hollow space HH in the frame. A rotatable main gear assembly 19 is mounted coaxially with the pivotable end of the rear wheel strut 16 on the lower end (bottom bracket) of the center seat tube 15. A drive chain 20 couples the main gear assembly 19 to a rear gear assembly 21 (hub gear or derailieur) for driving the rear wheel. Due to the pivoting of the rear wheel strut about the same axis as the main gear assembly during folding, the spatial relationship of the main gear assembly 19 to the rear gear assembly 21 remains the same with folding, and the gear assemblies do not need to be removed for folding the rear wheel 17 into the storage position in the hollow space HH or readjusted when unfolded.

The joinder of the main tube with the upper part of the center seat tube forms a corner space CC in which an engine unit 22 (optional, in dashed lines) may be mounted to a corner mounting bracket and connected by a chain drive to the main gear assembly 19. Since the engine unit CC is positioned alongside the center seat tube 15 in the corner from the hollow space HH, it does not need to be removed when pivoting the rear wheel into the storage position in the hollow space.

The engine unit 22 may be provided with a new bicycle unit or retrofitted as an option to augment human pedaling power. An example of a retrofittable electric motor unit is sold by EcoSpeed LLC, of Portland, Oreg. The electric motor output is coupled by a chain drive down to the pedaling crank attached to the bottom bracket spindle. This arrangement allows the rider and the motor to independently supply power to the main gear which drives the chain that drives the rear gear assembly.

A releasable front fork coupler 23 couples the upper branching end of the front fork 12 into the bottom end of the front steering tube 11, and is released to remove the front forks with the front wheel 13 still mounted thereon for storage in parallel with the rear wheel 17 when they are folded in the storage position. A quick-release pin 24 enables the yoke tube 25 mounting the handlebars 25a, 25b to be removed quickly from the front steering tube 11 and stored flat with the other folded parts of the bicycle. A quick-release mechanism (of conventional type) is also provided for removal of the seat 26 with its extension tube 26a from the top end of the center seat tube 15. A dismountable carrier tray (of conventional type) 27 may also be employed optionally (shown in dashed lines).

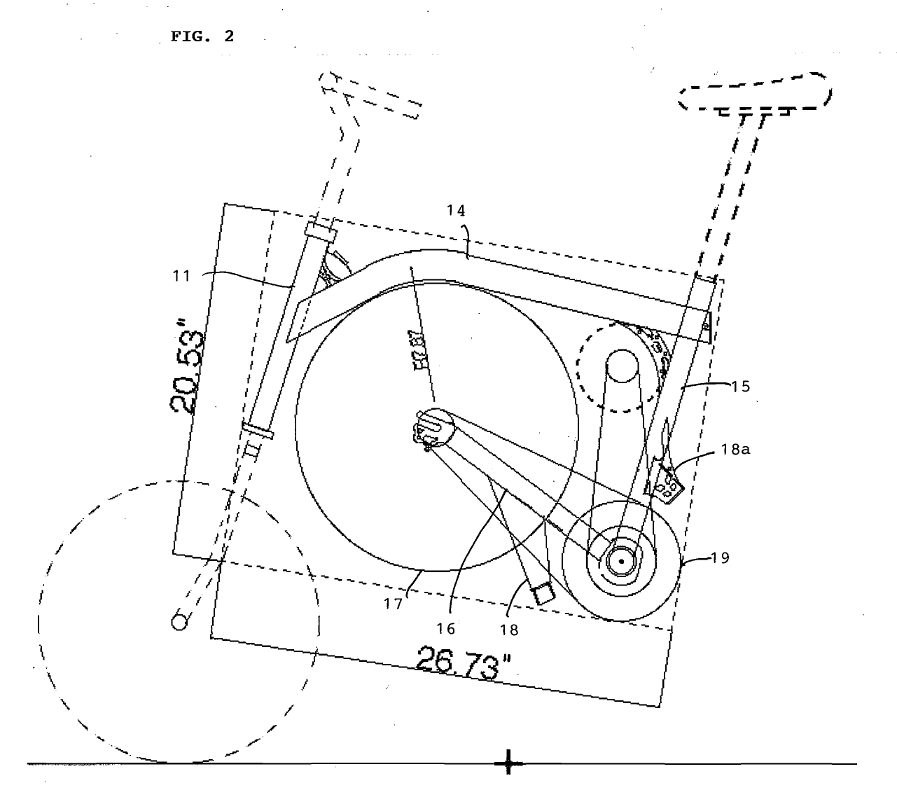

Referring to FIG. 2, the folding bicycle is shown with the rear wheel 17 rotated in its folded position within the hollow space HH defined by the front steering tube 11, main tube 14, and center seat tube 15. The main tube 14 is shown having a concave portion with a radius of curvature of about 8 inches to accommodate a rear wheel of 16 inches diameter. The front fork 12 and front wheel 13 are removed (shown in dashed lines) from the front steering tube, and nested in parallel on the rear wheel 17 in the folded position. The seat 26 and extension tube 26a are removed (also shown in dashed lines) from the center seat tube 15 and laid on top of the other parts. The handlebars 25a, 25b and yoke 25 are removed (also shown in dashed lines) and laid on top of the other parts for storage. If a rear carrier tray is used, it is also removed and folded flat and laid on the other parts for storage. Thus, all the parts of the bicycle can be disassembled and folded together within a compact space indicated by the rectangular box (shown in dashed lines) in the figure. For an embodiment having wheels of 16 inches diameter, the entire bicycle can be folded into a suitcase-sized space of about 21″ height×27″ length×9″ thickness.

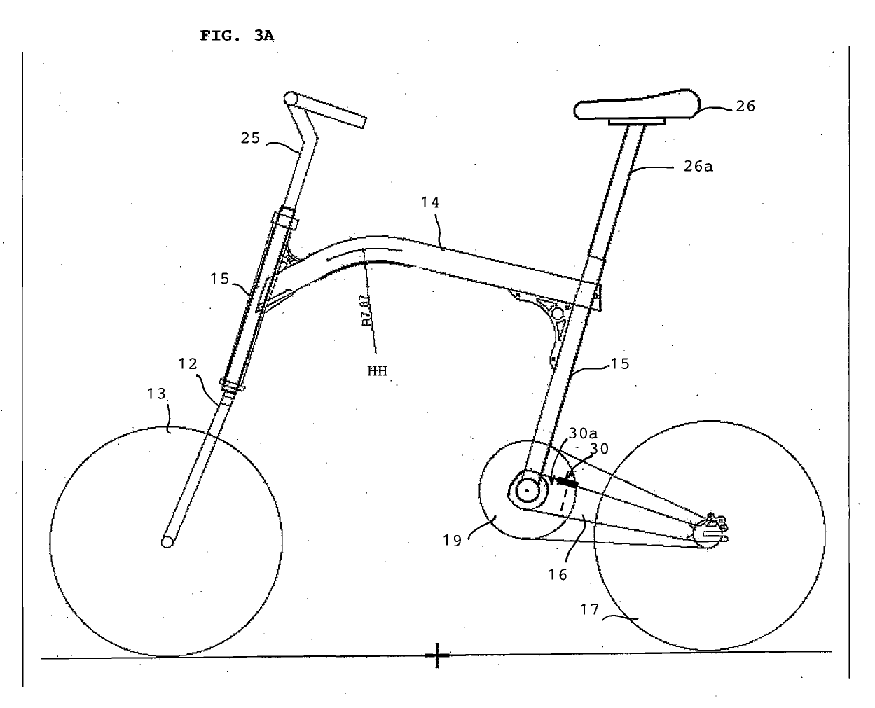

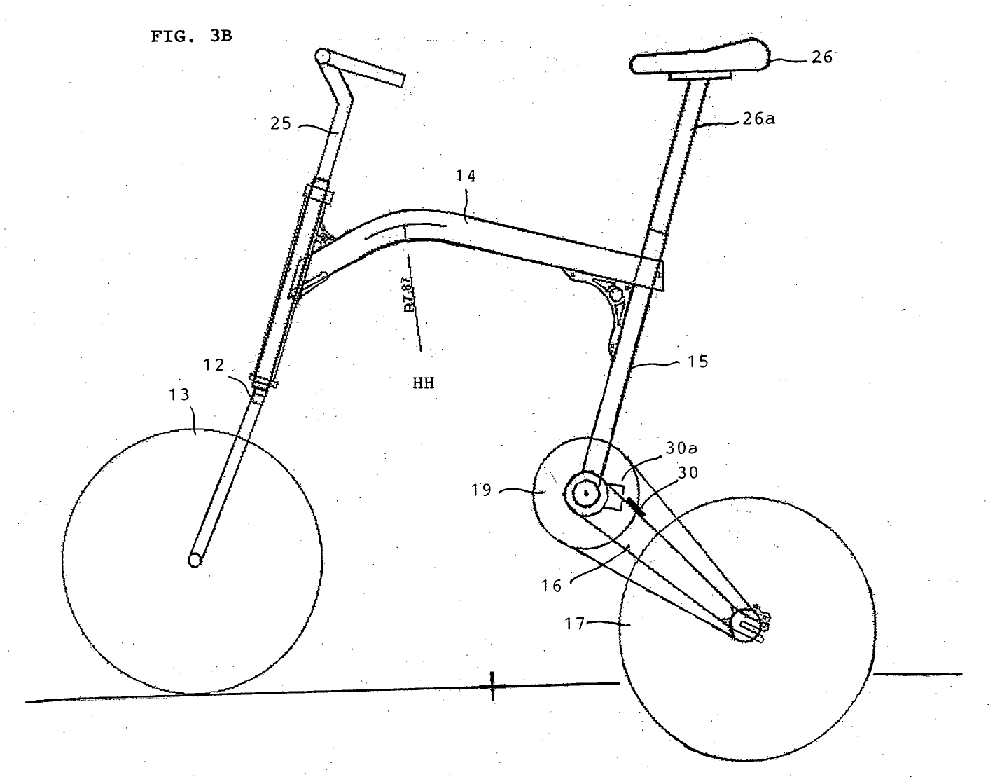

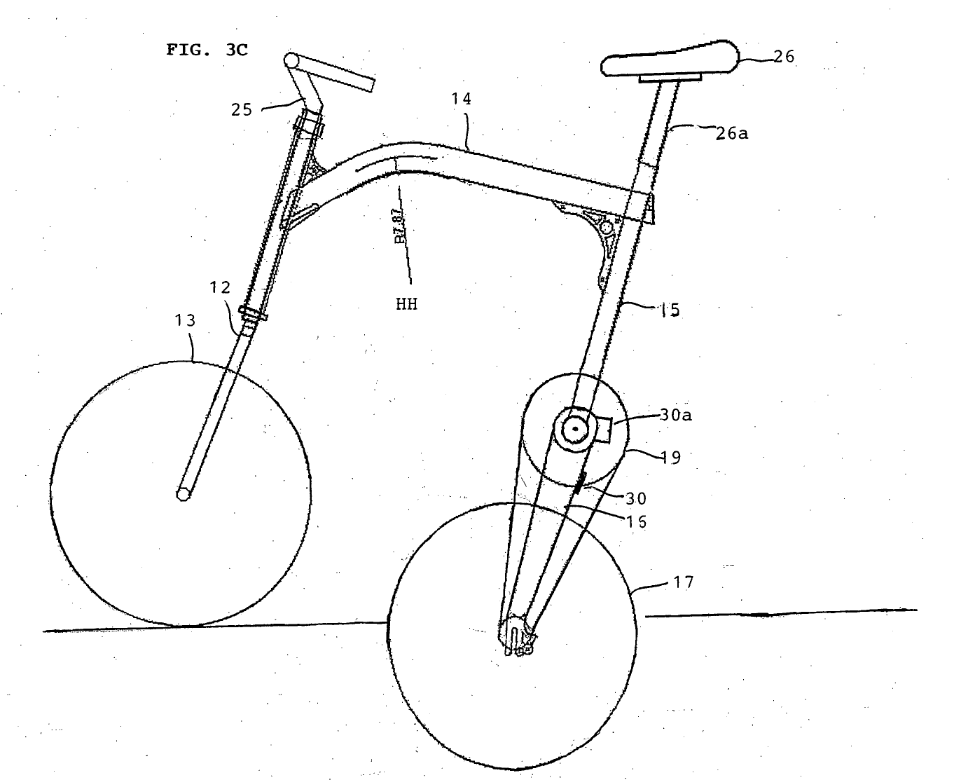

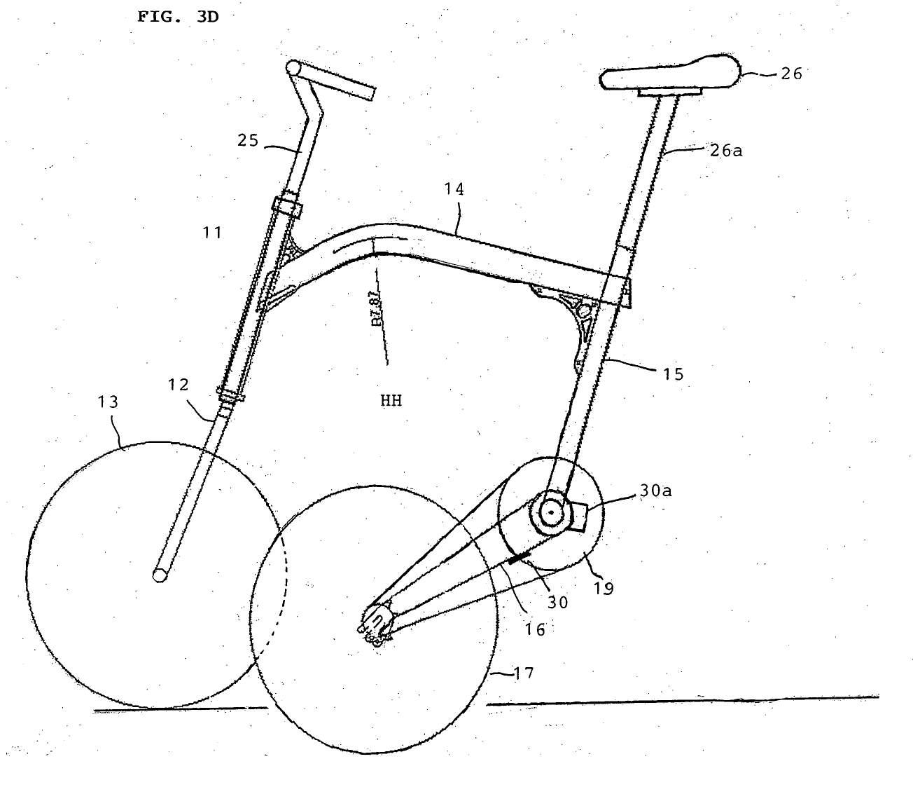

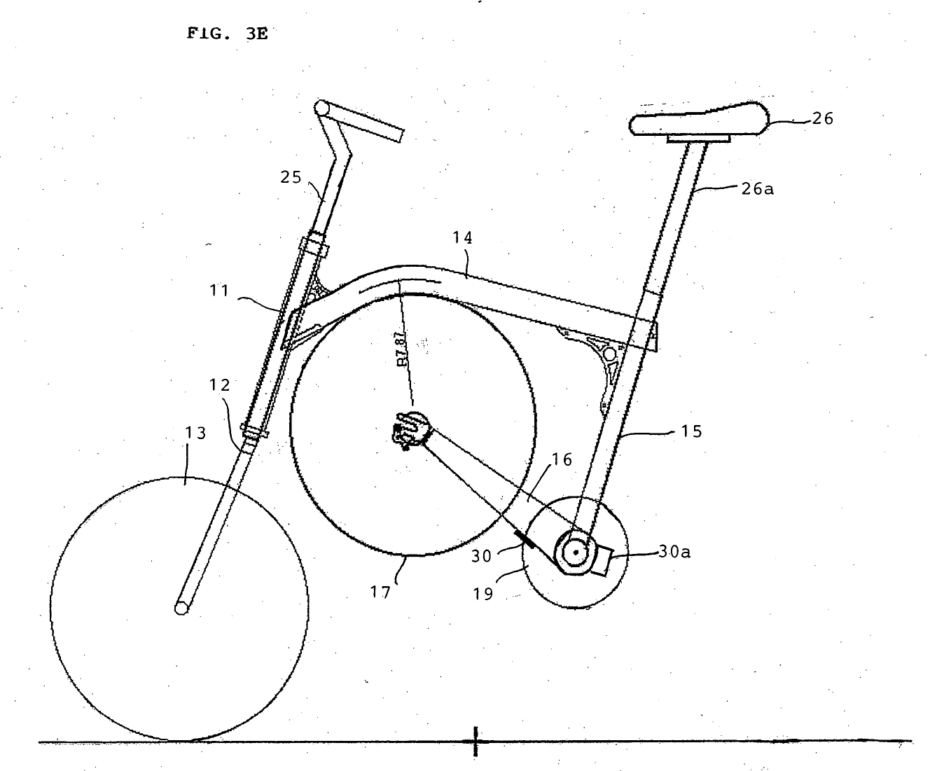

In FIGS. 3A-3E, another embodiment of the folding bicycle is shown similar to the first one (similar parts are numbered with the same reference numerals), except that instead of a support arm 18, the rear wheel strut 16 is locked in the riding position and unlocked for folding to the storage position by a latch member 30 which disengages the rear wheel strut 16 from a fixed part 30a fixedly mounted to a lower end of the center seat tube 15. The figures show the various various stages of folding the rear wheel from its locked position for riding, to an unlatched state, rotation around the bottom bracket of the center seat tube and into the hollow space HH of its storage position within the frame.

A key feature of the folding design of the present invention is that the pivot point for folding the rear wheel strut retaining the rear wheel uses the same axis of rotation as the main gear assembly. This is an improvement over previous folding bicycle designs in that it allows the chain drive to maintain its exact same length during and after the folding process. By comparison, previous designs that require folding of the rear wheel strut result in altering the distance between the main gear and rear wheel, thereby making them suitable only for chain drives, and even as to those the chain drive will come loose and be messy to handle during the folding process. The folding method of the present invention maintains the main gear to rear wheel hub relationship even during folding, making it suitable for use with internally driven rear hubs using internal gearing systems. The latter drive types are increasingly preferred because they are more weather-proof and more durable. Having the rear wheel fold around the bottom bracket on the main gear axis means that (with smaller wheels such as 16 inches diameter) the rear wheel can be rotated into the hollow space defined within the frame without the need to remove the rear wheel during folding of the bicycle. Thus, the present invention provides a more convenient folding method, and avoids the need for disassembly of entrained parts, messiness, and/or having to re-tension or re-adjust parts upon unfolding.

FIGS. 4A and 4B show detailed side sectional views of the latch member 30 in the second embodiment described above for locking (A) and unlocking (B) the rear wheel strut assembly to and from its riding position. The center seat tube 15 has a bottom bracket at its lower end in which pin 41 is journalled for retaining bearing rings 42a (paired with opposite 42b, not shown) of the pivotable end of the rear wheel strut 16 thereon. The rear wheel strut 16 has a pair of laterally spaced rear strut arms 43a (43b) which retain the rear wheel at their distal ends (not shown in the figure) which hold the ends of an axle on which a rear wheel hub rotates. A fixed part 30a of the rear wheel strut assembly is formed by a bolt 44 fixed (threaded) into the center seat tube 15 and encased by an elastomer block 44a which acts as a shock absorber for vibrations transmitted to the abutting bracket 47 of the rear strut arm from the rear wheel. Upper and lower support wings 45, 46 form the latching boundaries for retaining the head of the bolt 44 in the locking position. A latch 30 is pivotably mounted by a pivot pin 40b on the upper support wing 45, and is moved by a thumb tab 40a between a locking position, shown in FIG. 4A, in which it overlaps the head of the bolt 44 to lock the rear wheel strut 16 in the riding position, and an unlocked position, shown in FIG. 4B, in which it is released from the head of the bolt 44 to allow the rear lock wheel strut 16 to pivot downward around the bottom bracket and into the storage space HH. For riding use, the rear wheel strut 16 is maintained in a fixed position relative to the bottom bracket and rear wheel by rider weight. The latch 30 only needs to be rigid and strong enough to maintain the locked position against the weight of the rear wheel, so that the rear wheel does not drop when the bicycle is picked up.

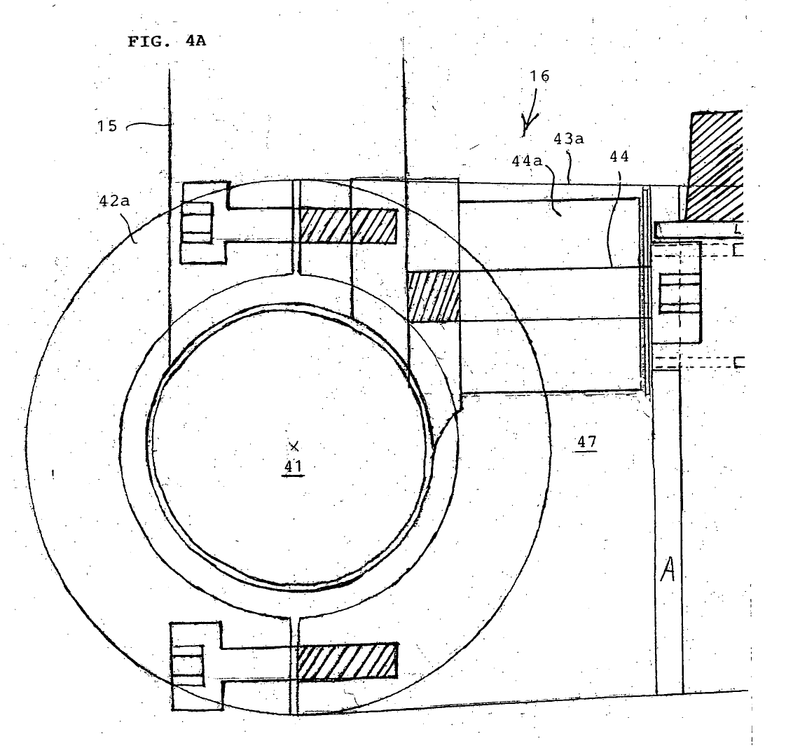

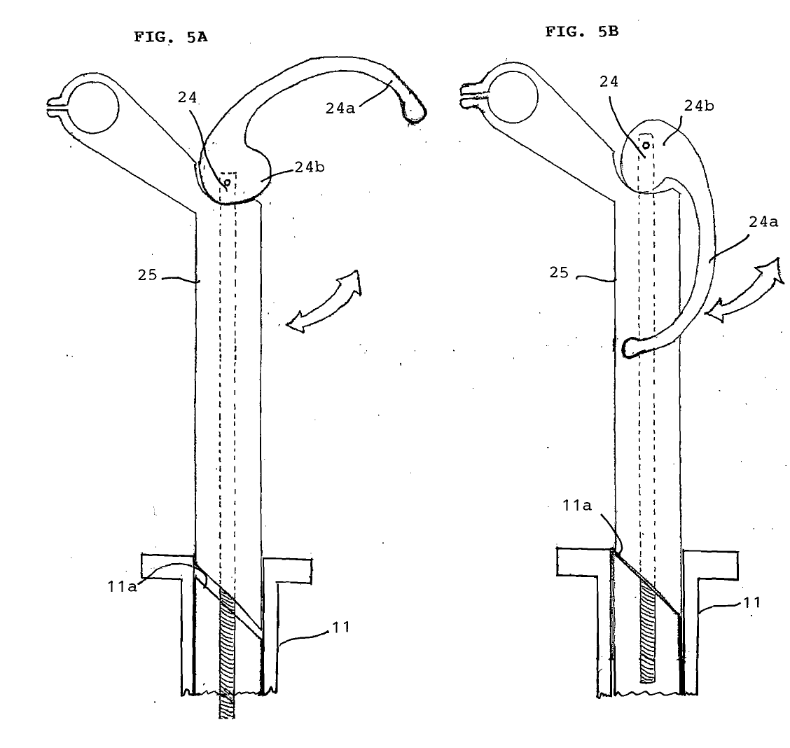

FIGS. 5A and 5B show detailed side sectional views of a quick-release pin for the handlebars. The retainer pin 24 is sleeved through an interior channel in the yoke tube 25 for mounting the handlebars (not shown) and threaded into a retainer block 11a retained in the top end of the front steering tube 11. In the release position shown in FIG. 5A, the handle end of the gooseneck lever 24a is rotated upward to release pressure on the cam end 24b and allow the pin 24 to be unthreaded from the block 11a for removal of the yoke tube 25. In the locking position shown in FIG. 5B, the handle end of the gooseneck lever 24a is rotated downward to apply pressure on the cam end 24b to tighten the retention of the yoke tube 25 against the retainer block 11a. With the gooseneck quick-release mechanism, the yoke tube 25 and handlebars can be quickly removed from the steering tube 11 for folding up the bicycle. In previous art, a simple drop-bolt was used, and required the use of a wrench to tighten or loosen the drop-bolt. The gooseneck quick-release mechanism replaces the need for a wrench with a simple lever that releases pressure on the pin and allows it to be unthreaded.

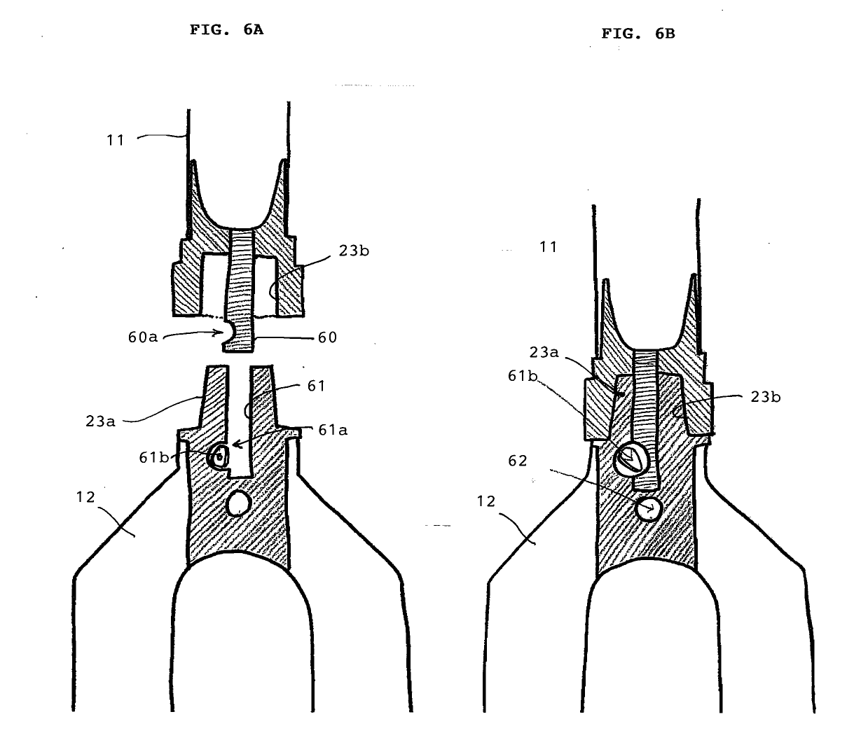

FIGS. 6A and 6B show detailed side sectional views of a quick-release fork coupler 23 for locking and unlocking the front fork 12 from the bottom end of the steering tube 11. The fork coupler 23 consists primarily of a squared, tapered male rod portion 23a mounted in the tube end of the front fork 12 that mates with a mirror-image female embrasure 23b mounted in the bottom end of the steering tube (or vice versa). A cam-lever locking system is used for ease of locking and unlocking. The female embrasure 23b has a center post 60 with a cut-out portion 60a to one side of its lower end. The male rod portion 23a has a center hole 61 for receiving the center post 60 therein. A cavity 61a formed in one side of the center hole 61 has a pivotable cam 61 b which can be turned downward to pull the male and female portions of the coupler 23 tightly together, as shown in FIG. 6B, or push them apart and release them when turned in the opposite direction as shown in FIG. 6A. A bolt hole 62 may be provided for optionally mounting a fender or side-pull brakes.

The cam 61b is held in place in the cavity 61a by an E-clip at its forward end. It is shaped to fit tightly in the cut-out portion 60a of the post 60 of the female portion that comes through the hole in the male portion of the fork coupler. A tool with an insertion end having a notch for engaging the E-clip is inserted from the side through an aperture to reach into the cam-retaining cavity 61a. The cam functions to pull the male and female portions together tightly and lock them by turning a little bit past its tightest point. A tight fit between the male and female portions is provided by dimensioning the male taper for a slight interference fit with the female receptacle walls at the bottom end of its insertion. When turned the opposite direction, the cam pushes the two portions slightly apart and unlocks the taper fit between the portions so that they can be easily pulled apart by hand the rest of the way.

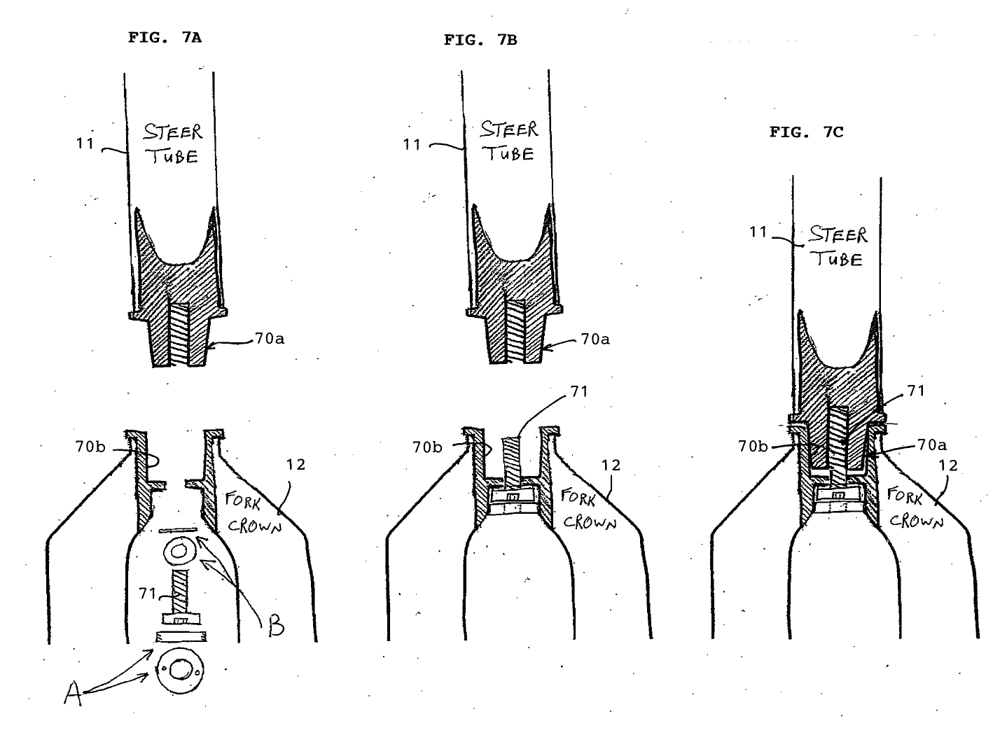

FIGS. 7A, 7B and 7C show detailed sectional views of an alternate version which reverses the male/female sides of the fork coupler. The male tapered rod 70a is mounted in the end of the steering tube 11, and the female receptacle 70b is mounted in the crown of the fork 12. This version of the fork coupler uses a standard “one-key release” bolt system, which requires an allen wrench for tightening and loosening. The male and female portions are pulled together tightly by threading the bolt 71 through a hole in the bottom of the fork crown, through the female embrasure 70b, and into a threaded hole in the male fitting, thereby pulling the embrasure tightly around the tapered male fitting. The male and female halves of the fork coupler are machined to very tight tolerance for an interference fit so that they hold together tightly. A cover “A” may be used to cover the hex head. A spacer B is used to allow the bolt 71 to be tightened securely against the receptacle of the female embrasure.

The square tapered cut (at 2.7 degree taper) of the male portion of the fork coupler may be replaced by a round splined rod (at 1 degree taper) and the equivalent mirror image female side for greater strength in holding the coupled portions.

Utilizing the above described folding method for the rear wheel and quick-release of its handlebars, front fork and front wheel, and seat, the folding bicycle can be quickly disassembled and folded compactly for storage fitting into a suitcase-sized space. Importantly, the rear wheel strut folds by pivoting on the same axis on which the main gear is mounted on the bottom bracket of the center seat tube, thereby maintaining the distance relationship between main gear and rear wheel during folding. Either the chain drive type with derailieur gears or internal hub-geared system may be used. The design of the frame allows for many sizes of rider (from about 4′6″ to about 6′4″). Instead of folding pedals, the side crank-arms and pedals may be made removable for greater compactness using standard one-key-release fittings. With these quick release parts, and front and rear wheels of 16 inches diameter, the entire bicycle can be folded into a suitcase-sized space of about 21 inches height, 27 inches width, and 9 inches thickness, with a total weight of under 25 pounds (excluding motor and battery). The bicycle design nevertheless rides extremely well, and provides the desired qualities of dependability, strength, ease of folding, and compact storage size.

The above-described design for the folding bicycle employs only a single main tube or “top-tube” connecting the head-tube and the seat-tube. This top-tube is curved to allow space for the rear wheel when it is in the folded configuration. The connection of top-tube to head-tube is stabilized and strengthened by the use of differing gussets, two on the top and one on bottom of the connection between the steer-tube and the top-tube. The top gussets can also be used to attach a carrying rack, such as for a battery for the electric drive. Further toward the rear, the top-tube connects to the seat-tube. This connection also utilizes a strengthening gusset, which doubles as the motor mount for the electric augmentation. It is also a stronger connection than many bicycles due to the seat tube being threaded through a retaining aperture in the larger diameter top-tube. The top-tube thus sticks out a bit behind the seat-tube. Near the rear of the top tube, a set of 6 threaded braze-on bolts can be provided for attaching reflectors, lights or carrying racks, the motor mount or any other desired thing. Above this is a standard seat post and seat, held in position by an industry standard binder bolt or quick release.

The seat-tube is terminated at its lower end with a standard, 73 mm wide, bottom bracket with standard bearings and axle within it. The bottom bracket can have 2 antifriction devices surrounding it, one on each side of the seat-tube, such as bushings made of bearing bronze, needle roller bearings, Delrin bushings, sealed ballbearing systems, etc. Surrounding these bushings are 2 bearing clamps. Welded or brazed to the outer surface on the rear side of both clamps are the oval tubes that are called (in bicycle terminology) the chainstays. These are also held in place by a cross bar welded in place between them in front of the rear wheel. The chainstays have, at their other ends, a laser-cut plate metal that is the custom rear drop out, to which the standard 16″ rear wheel hub attaches (nuts or quick release).

It is to be understood that many modifications and variations may be devised given the above description of the principles of the invention. It is intended that all such modifications and variations be considered as within the spirit and scope of this invention, as defined in the following claims.

1. A folding bicycle comprising:
(a) a frame having a front steering tube for mounting a front fork for retaining a front wheel at a lower end thereof, a main tube connecting an upper part of the front steering tube to an upper part of a center seat tube, and the center seat tube extending downwardly to a lower end thereof on which a rotatable main gear for driving a rear wheel is mounted concentrically with an end of a rear wheel strut for retaining a rear wheel at a rearward end thereof;
(b) a hollow space defined by the front steering tube, main tube, and center seat tube being configured and having dimensions for accommodating the rear wheel when folded therein; and
(c) a releasable support member engageable between a fixed part mounted to the lower end of the center seat tube and the rear wheel strut for locking the rear wheel strut in position for riding, and disengageable therefrom so as to allow the rear wheel strut to pivot with the rear wheel around the lower end of the center seat tube into the hollow space for storage.

2. A folding bicycle according to claim 1, wherein the main tube has a concave curvature in a part extending from the front steering tube to the upper part of the center seat tube approximately matching the curvature of the rear wheel when pivoted into the hollow space in the frame.

3. A folding bicycle according to claim 1, wherein the rear wheel strut is pivoted on the same axis as the main gear such that a distance relationship between the main gear and rear wheel is not changed when it is pivoted into the hollow space.

4. A folding bicycle according to claim 1, wherein the main tube is joined to the upper part of the center seat tube so as to provide a corner space in which an engine unit may be mounted and connected to the main gear for supplementing drive power to the rear wheel.

5. A folding bicycle according to claim 1, wherein the releasable support member is an assembly that extends between an intermediate part of the center seat tube and respective rear strut arms of the rear wheel strut, having a fixed part mounted fixedly to the center seat tube, a releasable part coupled to the rear strut arms of the rear wheel strut, and a release member for engaging and disengaging the releasable part from the fixed part.

6. A folding bicycle according to claim 1, wherein the releasable support member is comprised of fixed part mounted fixedly to the center seat tube, a releasable part coupled to the rear wheel strut, and a movable latch mounted to the releasable part for engaging and disengaging it from the fixed part.

7. A folding bicycle according to claim 1, wherein the releasable support member includes a shock absorber for absorbing vibrations transmitted from the rear wheel to the rear wheel strut.

8. A folding bicycle according to claim 1, further having a releasable front fork coupler for coupling a tube end of the front fork into the bottom end of the front steering tube, and for releasing the front fork with the front wheel for storage.

9. A folding bicycle according to claim 1, further having a quick-release goose-neck release pin for coupling a yoke tube holding handlebars for the bicycle to an upper end of the front steering tube, and for releasing the yoke tube and handlebars for storage.

10. A folding bicycle according to claim 1 adapted to employ wheels of 16 inches diameter, and being foldable into a suitcase-sized space of about 21 inches by 27 inches by 9 inches.

11. A folding bicycle according to claim 8, wherein the fork coupler is formed with a tapered male rod portion mounted in one tube end and a female embrasure portion mounted in the other tube end, and the tapered male rod portion and female embrasure portion are dimensioned to fit together tightly with a slight interference fit when they are mated together along a tapered surface of the male rod portion.

12. A folding bicycle according to claim 11, having a cam-lever locking system for ease of locking and unlocking, wherein the female embrasure portion has a center post with a cut-out portion to one side of its lower end, and the male rod portion has a center hole for receiving the center post therein, and a cavity is formed in one side of the center hole having a pivotable cam which is turned in one direction to pull the male and female portions tightly together, and turned in the opposite direction to push them apart and release them.

13. A folding bicycle according to claim 11, having a one-key release bolt system with a threaded bolt which is inserted through a hole in a bottom crown of the front fork, through the female embrasure portion mounted in the tube end of the front fork, and into a threaded hole in the male rod portion for pulling the female embrasure and tapered male rod portions tightly together.

14. A front fork coupler for a folding bicycle, of the type having a front steering tube with a lower tube end releasably coupled to a tube end of a front fork for mounting a front wheel of the bicycle, said front fork coupler comprising a tapered male rod portion to be mounted in one tube end, and a female embrasure portion to be mounted in the other tube end, wherein the tapered male rod portion and female embrasure portion are dimensioned to fit together tightly with a slight interference fit when they are mated together along a tapered surface of the male rod portion.

15. A front fork coupler according to claim 14, further comprising a cam-lever locking system for ease of locking and unlocking the male and female portions, wherein the female embrasure portion has a center post with a cut-out portion to one side of its lower end, and the male rod portion has a center hole for receiving the center post therein, and a cavity is formed in one side of the center hole having a pivotable cam which is turned in one direction to pull the male and female portions tightly together, and turned in the opposite direction to push them apart and release them.
